(19) United States
(12) Patent Application Publication
(10) Pub. No.: US 2007/0029779 A1
(43) Pub. Date: Feb. 8, 2007

(54) Opposed pocket assembly of presentation folder intermediate blanks and construction resulting therefrom

(75) Inventors: Amy L. Silvers, Fort Scott, KS (US); Gregory Shane Fess, Arcadia, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/166,757

(22) Filed: Jun. 24, 2005

(51) Int. Cl. B42D 3/00

(52) U.S. Cl. 281/29

(57) ABSTRACT

The present invention relates to a presentation folder construction in which first and second pockets are provided on each of first and second intermediate blanks. The blanks are substantially juxtaposed on one another to create an assembly in which the pockets of each of the intermediate blanks lie in an opposed relationship to one another. The resulting construction has increased document retention capacity and in one embodiment additional available landscape to receive printing relating to a product, service or topic offered with the distribution of the presentation folder assembly.

### CROSS-REFERENCES TO RELATED APPLICATIONS

None.

### FIELD OF THE INVENTION

The present invention relates to an assembly of sheet stock intermediate blanks that are suitable for use in creating an arrangement that may be formed into at least a duplex type, juxtaposed presentation folder configuration. More particularly, the subject of the present application relates to a directly opposed construction of pocketed folder blanks that are disposed in a face-to-face arrangement, which creates an increase in the available content retention capability of the resulting presentation folder construction. The instant invention provides the manufacturer of presentation folders and the presenter of products, services and educational subjects with the ability to create personalized presentation folders on demand in limited, individualized quantities to meet a specific need or niche application.

The subject intermediates of the present specification are provided generally in a planar, sheet form, with one or more strips or patterns of adhesives applied in marginal areas to create folder pocket combinations. The resulting construction can be imprinted or imaged with specific or individualized communications or messages in order to create a significantly greater message transmission vehicle for the advancement of product, services, topics, concepts, theories or ideas.

The assembly produced from the intermediate blanks also provides a centrally configured area that can be used to further illustrate or highlight a particular product or service without reducing available pocket space or limiting the retention space for inserted sheets or samples.

### BACKGROUND OF THE INVENTION

Stock folders are generally well known today and are provided in a variety of colors and typically in several standard formats. Such stock products are created from a blank of material to which at least one and usually two pockets are provided on the inner face of the blank. The pockets are generally formed from the same sheet or blank and are then folded over onto the blank and sealed to the blank to create the pocket having normally, one closed and one open end. The blank is then folded, usually centrally, to form two relatively equal sides. The typical folder dimensions have a length of about 12 inches and a pair of panels each of which is about 9 inches, thus a standard folder runs roughly 12″ by 18″.

Such folders are used in a wide variety of applications ranging from academic, such as in an elementary, middle school, high school or collegiate environment to professional education purposes including seminars and technical symposiums. In addition, folders have also been used in the past to hand out information on products and services in the hopes of inducing purchases or sales of such products or services.

These prior art folders are provided in a broad spectrum of colors and can even have different finishes such as a glossy or a metallic appearance in order to supplement the product of topic offering. In addition, such prior art products may also be provided with textural or tactile features so as to resemble grains in leather or wood, again all in an effort to produce or tailor the communication vehicle to the audience or presenter to garner more attention for the products or services being offered.

Examples of such prior art folders include U.S. Pat. Nos. 3,870,223, 4,109,850, 4,301,962, 4,731,142, 4,989,777 and 5,836,507. Each of these prior art constructions are constructed from a single blank of material. That is, the portion making up the folder and which comprises the pocket are part of the same blank. The portion which becomes the pocket is then folded onto the folder portion to create the pocket portion. Such constructions normally require the manufacturer to purchase expensive and complicated folding equipment in order to process and fold the pocket portion, see for example U.S. Pat. Nos. 5,439,436 and 6,063,226.

One of the difficulties with such stock folder products is that the user of such products must order the folders in large lots, or must select from a generic stock inventory that may only have a pre-determined number of colors or finish options. If a presenter or distributor would prefer to have at least limited information printed on the folder, such as the name of the company or presenter or to have certain colors or finishes that represent the company, such as to emphasize the trade dress, then the user is stuck with the unfortunate option of having to order such products in large quantities. Typically orders have to be greater than 50 and more often in the hundreds as the set up for the production folders is complex and orders in the hundreds of units are normally required by the manufacturer due to the complexity associated with such set up of equipment. This dilemma has thwarted the growth of the folder industry and prevented the use of this tool from expanding its communication potential to users of the product.

Attempts at personalization or individualization have sometimes been elaborate, such as that illustrated by U.S. Pat. No. 5,882,038 in which a personalized sheet is printed and then inserted so that the personalized information is then visible through die cut windows in the blank. As one might imagine, this limits the amount of personalization that can be provided and also requires that the information be aligned with the windows in the folder assembly so that it is visible. In addition, to the steps of folding the blank and the equipment required therefore, in order to manufacture such a product one needs to add additional die cutting stations and then is faced with the challenge of inserting the personalized sheet of information. In preparing for a meeting, even a small meeting, having to insert 10 sheets into 10 different folders can be time consuming, particularly if one is rushed in trying to get to the meeting.

The foregoing prior art products also suffer from the fact that they are provided only in a relatively few standard configurations, choices of only one or two products having only one or two pockets. This may require the presenter to over stuff the pockets provided with the folder or alternatively to have to distribute multiple folders in order to achieve the communication that is intended, that is in order to discuss multiple products or services multiple folders need to be provided to the attendees of the meeting. In addition, attendees may also wish to include materials collected at the event such as notes, brochures or other collateral material and are faced with stuffing the material into already tight spaces or simply dropping them internally in the folder which can lead to the materials being lost as they are not secured by a pocket. The ability to add additional folder assemblies or pockets is simply not an option or if it is it may be an expensive option requiring the manufacturer to purchase additional equipment, rework existing equipment or obtain further tooling in order to produce what may only be a single order.

Another problem faced by users of such stock folders is that they have virtually no personalized or individualized information. For example, in a typical introductory business meeting between two entities, the attendees may include an executive, members of sales and marketing and production personnel. Distributing the exact same information to each attendee may result in the information simply being deposited into the attendee's files, instead of the presenter's intent of delivering a specific message to each participant. Any personalized or individualized information is then limited to the sheets that are included inside the folders and those specific to a particular attendee may be buried deep within myriad of pages of information provided to the attendees.

Publications, patents and patent applications are referred to throughout this disclosure. All references cited herein are hereby incorporated by reference.

What is needed therefore is a product that can be produced in a convenient manner that overcomes the foregoing drawbacks. In addition, what is needed is a product that can be customized and tailored to the individual needs of a customer or presenter and one which enables the customer or presenter to convey personalized or individualized messages so as to increase the impact of the delivered materials. Moreover, the ability to provide any number of pockets as part of a presentation folder assembly would assist in the direct marketing effort to each of the attendees.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention relates to a unique presentation folder assembly that is created through juxtapositioning one presentation folder having a pair of pockets, one on each face of a front surface, onto another similarly prepared folder such that pockets provided on each of the folders are in a directly opposed configuration with one another and the sides, edges and medial fold lines of each of the folders are in substantial alignment with one another. The assembly of the present invention may further include additional presentation folders or intermediate blanks that are disposed in an overlapping relationship to create modified configurations of the construction described above.

It has been found that through the unique arrangement described herein, that a presentation folder can be created that has significantly increased document retention capacity as well as one that may provide additional printable landscape for communicating to a recipient, information relating to a particular product, service or topic.

In one exemplary embodiment of the present invention, a directly opposed pocketed intermediate presentation folder configuration is described and includes, at least first and second intermediate blanks with each of the blanks having first and second transversely extending edges, first and second longitudinally extending sides, top and bottom surfaces and first and second faces on each of the surfaces.

Each of the first and second intermediate blanks is provided with first and second pockets with the first pocket being disposed over the first face and the second pocket disposed over the second face. A fold line is provided on each of the blanks and runs between the transversely extending edges so as to divide each of the blanks into first and second faces.

Continuing with a description of the presently described embodiment, the second blank is juxtaposed on the first blank such that each of the longitudinally extending sides, transversely extending edges and the fold line are all substantially parallel with one another. When the blanks are arranged in this configuration, the first and second pockets of each of the blanks are then in a face to face alignment with one another creating an opposed pocket presentation folder assembly.

In a still further embodiment of the present invention, a presentation folder assembly having an opposed pocket configuration is presented and includes, a first presentation folder that has first and second transversely extending edges, first and second longitudinally extending sides, top and bottom surfaces, first and second faces on each of the top and bottom surfaces and first and second pockets with one of the first and second pockets provided on each of the first and second faces of the top surface.

At least a second presentation folder is provided that has first and second transversely extending edges, first and second longitudinally extending sides, top and bottom surfaces, first and second faces on each of the top and bottom surfaces and first and second pockets with one of the first and second pockets provided on each of the first and second faces of the top surface.

The second presentation folder is then placed so as to be substantially juxtaposed over the first presentation folder so that the first and second pockets of the second presentation folder are in an opposed relationship to the first and second pockets of the first presentation folder and the first and second transversely extending edges and the first and second longitudinally extending sides are in parallel alignment with one another.

In a yet still further embodiment of the present invention, a presentation folder intermediate assembly having opposed pocket configurations is described and includes a first blank of material that has first and second transversely extending edges, first and second longitudinally extending sides, top and bottom surfaces with each surface having first and second faces, a medially extending fold line and first and second pocket portions formed from the blank having wing areas with each of the pocket portions folded over the first and second faces to form pockets when the wing areas are folded perpendicularly to the pocket portions.

At least a second blank of material is provided in connection with the presently described embodiment with the second blank having first and second transversely extending edges, first and second longitudinally extending sides, top and bottom surfaces with each surface having first and second faces, a medially extending fold line and first and second pocket portions formed from the blank having wing areas with each of the pocket portions folded over the first and second faces to form pockets when the wing areas are folded perpendicularly to the pocket portions.

The second blank of material is juxtaposed on and adhered to the first blank of material so that the first and second pocket portions are directly opposed to the first and second pocket portions of the first blank of material and the medial fold lines of each of the blanks are in substantial parallel alignment with one another.

In each of the foregoing embodiments, the bottom surface of the second intermediate or second folder may be provided with a pattern of adhesive that is disposed around the periphery of the surface such that the first and second faces of the bottom surface are adhered to one another to create a sealed area centrally disposed of the construction. In an alternative embodiment, the first and second faces of the bottom surface of the second intermediate or folder as well as the first and second faces of the bottom surface of the first intermediate or folder may be provided with printing or imaging, that may include textual or graphical dictions or combinations thereof.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a front view of an intermediate blank used to form the opposed pocketed configuration of the present invention;

FIG. 2 shows a front view of a blank that is used to form the intermediate blank depicted in FIG. 1;

FIG. 3 provides a side elevation of the opposed pocket configuration of the assembly of the present invention taken along the transversely extending end edges;

FIG. 4 illustrates a further side elevation taken along the longitudinally extending sides of the assembly; and

FIG. 5 shows a further exemplary embodiment of the present invention, taken along the transversely extending end edges in which additional folder intermediate assemblies have been joined to create a multiple pocketed configuration.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

Unexpectedly, the inventors of the present invention have found that substantially the full use of the blank is possible when creating a presentation folder so that imaging can be provided to convey a message. In addition, the sheet intermediate used in forming the construction of the present invention can be used to complement the message being presented thereby increasing the total amount of “landscape” available for communicating with the audience.

The present invention, through the use of sheet intermediates, can create fully perso nalized and individualized presentation folders having increased document or sample retention capacity. In addition, the presentation folder created through the use of the sheet intermediates of the present invention is not limited to any particular configuration and instead can be provided in any number of constructions to accommodate the conveyance or transmission of the relevant marketing message or educational topic.

Unexpectedly, it was found that such a system and method was not available in today's marketplace but that one is urgently needed to fill a niche that is currently not being serviced by large folder manufacturers and other producers of signatures that may be produced or provided in a book.

The printing or imaging that can be provided on the blank and pocket can be personalized or individualized so that each attendee of a business meeting can receive a specially tailored message. For example, a normal introductory business meeting, the attendees from the target company (company that is being targeted for the sale of goods or services) may have an executive present, members of the sales and marketing team as well as production personnel in attendance to consider the information being provided. The presenter ideally wants to deliver a unique message to each person or group in the audience and is only offered a short period of time to accomplish this task, and usually devotes most of the period to “walking through” a visual presentation. However, through the use of the present invention, the presenter can deliver personalized or individualized information to each group while still focusing on delivering the information to the group. For example, information for sales and marketing may relate to increased sales and commissions or sales strategies for selling the product. Production personnel may receive information relating to efficient manufacturing techniques and other products for which the services may be used as well as contact numbers for support and other technical data. The executive may only receive summary or overview information and financial numbers relating to the impact of the divisional bottom line. Thus each person is provided with a unique package of information that is tailored to his or her specific talents thereby potentially increasing the chances of success of the presentation.

The term “personalized information” refers to information that is printed or imaged onto a substrate, which is generally variable or unique and which may change from document to document or segment to segment, so as to create a customized message or communication for each recipient. Examples of personalized information may include names, addresses, descriptions, plans, coding, numbering, promotional text, etc. that may have been acquired from the intended recipient through surveys, questionnaires or answers given to various inquiries generated in response to a request for goods or services.

The term “static or fixed” information refers to printed or imaged information that generally does not change from document to document or segment to segment and may include a general description or body of information about particular products, services, places, etc. that may be of interest to the intended recipient and represents a standard message that the manufacturer or supplier wishes to convey to an end user or customer of the offering.

The term “intermediate” as used herein, refers to a product that undergoes one or more processing steps prior to the intermediate reaching a final condition, that of being ready for end use or application. The additional processing steps may include printing, imaging, folding, sealing, separating, cutting, perforating, scoring, adhering and the like. Typically, a product, such as with the present invention, is provided in an intermediate condition so that a user can add or manipulate the intermediate to create the final or desired end product. Thus, in accordance with the present invention, the intermediate segment, for example, could be subject to die cutting or additional printing, such as through ink jetting, over laminating, coating or embossment prior to being distributed as part of a presentation, promotional or marketing campaign or the like.

As used herein, the term “adhesive” includes, but is not limited to strips, patterns, segments, shapes, spots, continuous arrangements, discontinuous arrangements and combinations thereof. The type of adhesive that may be used includes but is not limited to repositionable, removable, permanent, remoistentable, hot melt, pressure seal (cohesive), cold glues and combinations and mixtures thereof. The present invention may also include adhesive strips that are provided in the form of transfer tapes, pressure sensitive tapes and the like which usually will have a removable release liner, which when removed will expose and/or activate the adhesive that can be used to form a sealing arrangement.

The term “document containment device” as used herein includes portfolios, notebooks, binders, clipboards, sleeves, folders, envelopes, accordion folders and the like.

The intermediate blank used in connection with the practice of the present invention may be manufactured from a standard sheet size with the unused portions of the sheet stock being cut or severed from the sheet such as through die cutting and other means as are known in the industry. The material selected for use in the present invention may include any suitable material such as bond paper, card stock, tag stock, plastic films or sheet or any other material that may be die cut and receptive to adhesive, printing or imaging.

Each of the portions of the sheet intermediate that will form the panel of the presentation folder or folder page, after forming will in one exemplary embodiment have a width of approximately 9 inches and a length of about 12 inches. The pockets formed from the present invention will have a height of around 4″ to 4¼″ and a width of up to 9 inches. The flaps that are provided on each of the panel and pocket portions of the sheet intermediate range from roughly ¼″ of an inch up to about 2 inches. The width of the flap used in the sealing of the construction, either the pocket or the sheet to a blank so as to create the folder itself, is dependant upon the dimensions necessary to accomplish the needs of the manufacture to meet the specifications and demands of the customer or end user.

The foregoing dimensions are used when preparing a standard configuration presentation folder. That is, each panel of the blank runs about 12″ high and about 9″ wide with the pocket having a length of about 9″ and a height of around 4″. Obviously, other dimensions are possible and would simply require the repositioning of the adhesive areas, lines of weakness, etc. on the sheet or use of different sized sheets of material. The pocket of the presently described embodiment is sized and configured so that it can receive and retain a standard size sheet of paper in a portrait arrangement (8½ side placed in the pocket which has a width of approximately 9″).

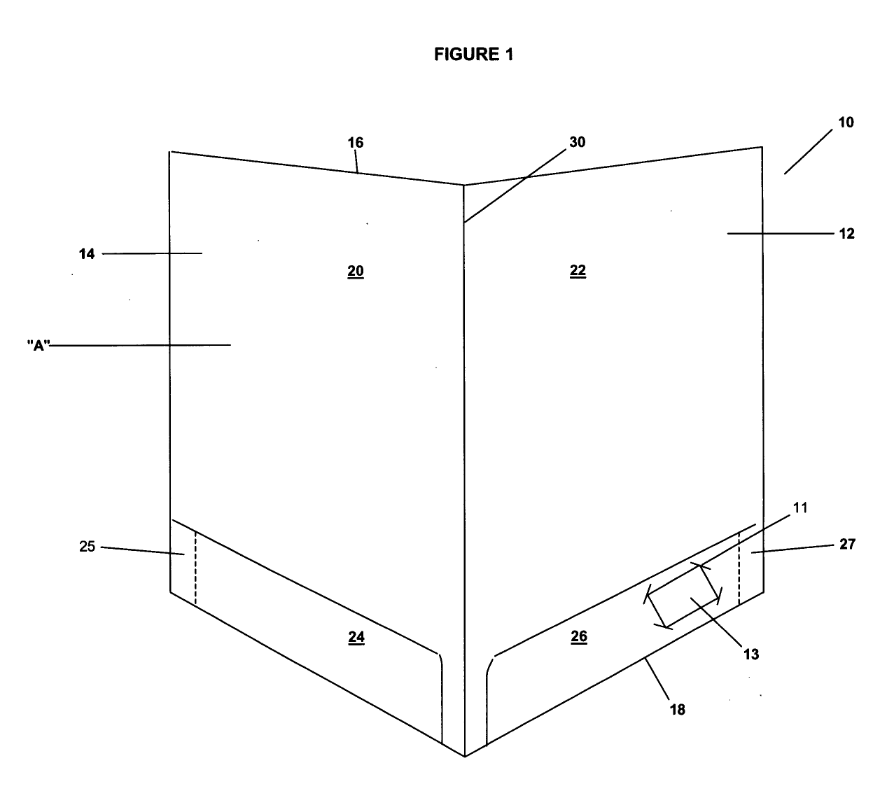

Turning to FIG. 1 of the present invention, an intermediate presentation folder blank assembly, generally depicted by reference to numeral 10, is shown and includes first and second longitudinally extending sides 12 and 14 and first and second transversely extending edges 16 and 18. The intermediate blank 10 also has a top surface “A” and a bottom surface “B” which is opposite the top surface and is not shown in the present drawing. The top surface has first and second faces 20 and 22, respectively.

Each of the first and second faces 20 and 22 is provided with a pocket 24 and 26 which is created by folding a portion of the blank onto the face portion of the sheet and then securing an edge portion 25 and 27 either through the use of a pattern of adhesive or alternatively, by folding over a flap which is then secured by adhesive. The intermediate 10 also includes a fold line 30 that substantially divides the blank 10 into equal halves. It should however be understood that the fold line may dissect the blank in to different sized halves, such as one side being roughly equivalent to one third of the surface and the other side being roughly equivalent to two thirds of the surface of the assembly.

The folder intermediate assembly in FIG. 1, may also be provided with slits or cuts 11 that may be used to hold supplemental items such as business cards 13, discs, diskettes, chips, tags and combinations thereof. By including supplemental items then each pocket in the assembly can convey or hold specific information, but unique contact or pre-recorded information can further accompany the materials to enhance the offering. In this way, other communication means are provided to better enable the communication to be transmitted to the recipient.

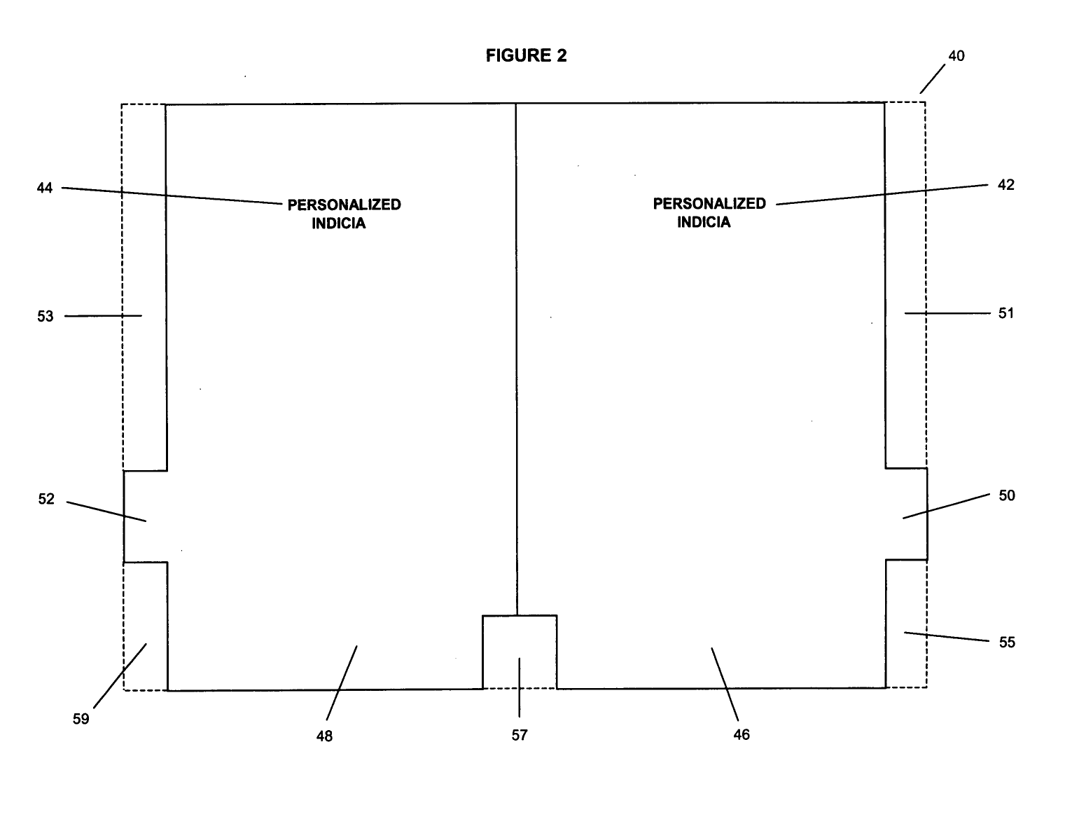

In preparing the folder intermediate of FIG. 1 a flat sheet stock 40 as shown in FIG. 2 is preferably printed with personalized or variable indicia 42, 44 that relate to the customer, with high quality graphics, text or other imaging using a sheet fed printing apparatus. Examples of image generating devices include high resolution imaging devices such as Indigo®, available from Hewlett Packard of Palo Alto, Calif. or Karat available from KBA of Williston, VT. Ideally, the printing will have a quality of about 150 or more lines per inch and preferably more than 300 lines per inch, which is approximately equal to about 2500 to 3500 dots per inch (“DPI”) in order to create a high quality image that is intended to be aesthetically appealing to the consumer.

The blank 40 is then cut, such as by using a laser die cutter, mechanical cutter, guillotine or other suitable means known in the industry. Portions of the sheet 40 that will become the pockets 46 and 48 and flaps or wings or glue tabs 50 and 52 are cut and other areas to be removed 51, 53, 55, 57 and 59 are shown in phantom. Each of the pocket portions 46 and 48 are then folded up on to the first and second faces of the top surface and the flaps 50 and 52 are folded over to create sealed end edges through the use of applying a pattern of adhesive. The blank has then been folded and formed into the intermediate that is presented in FIG. 1.

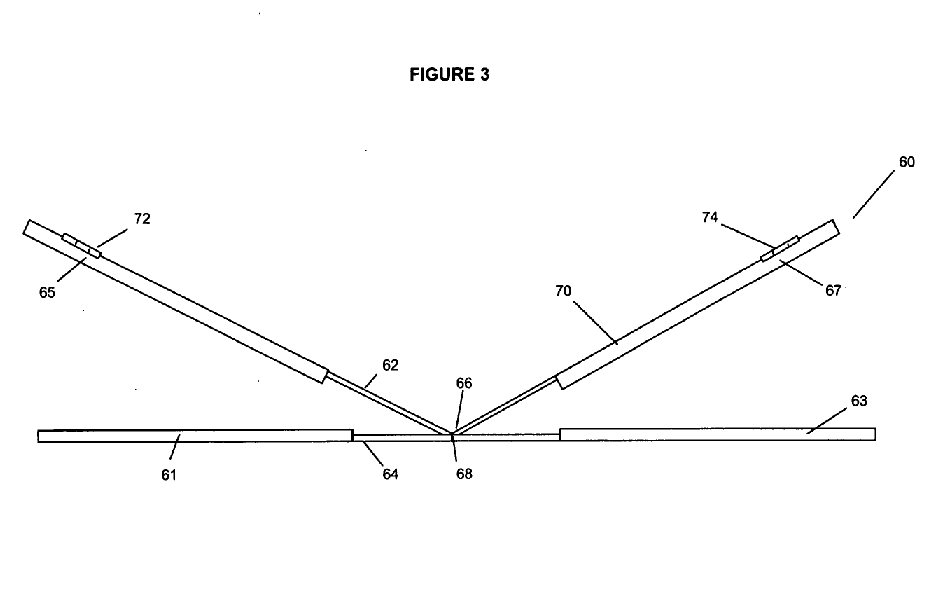

FIG. 3 presents a side elevation of the opposed pocket configuration of the present invention that is taken along the longitudinally extending sides of the presentation folders used in creating the construction of the present invention. The assembly is generally depicted by reference to numeral 60 and includes first and second presentation folders 62 and 64 with each having longitudinally extending sides, transversely extending edges, top and bottom surfaces and first and second faces on each of the surfaces as described in connection with FIG. 1.

Each of the presentation folders is provided with pockets, 61 and 63 being associated with folder number 64 and pockets 65 and 67 affiliated with folder 62. The pockets are provided on the top surface on each of the first and second faces of the folder assemblies such that the pockets 61 and 65 and 63 and 67 are disposed in direct opposition to one another. That is, when the first and second folder assemblies are juxtaposed on one another so that the sides, edges and medial fold lines (66 and 68) are placed substantially in parallel with one another the folders will be in facial contact with one another.

Still referring to FIG. 3, the bottom surface 70 of second presentation folder 62 may be used in one of two alternate embodiments. In a first embodiment, the bottom surface may be printed with static, personalized or variable printing or imaging such that when a recipient opens the folder assembly 60, additional information and messages concerning the product, service or topic may be provided.

In the second alternate embodiment, the bottom surface 70 may be provided with patterns of adhesive, for instance in the marginal areas as represented by numerals 72 and 74 such that each of the faces of the bottom surface of the second folder 62 may be joined to one another to create sealed central portions such that there is no open central area.

The first and second folders 62 and 64 depicted in FIG. 3 may be joined to one another by any suitable means, including through the use of adhesive, staples, stitching and the like.

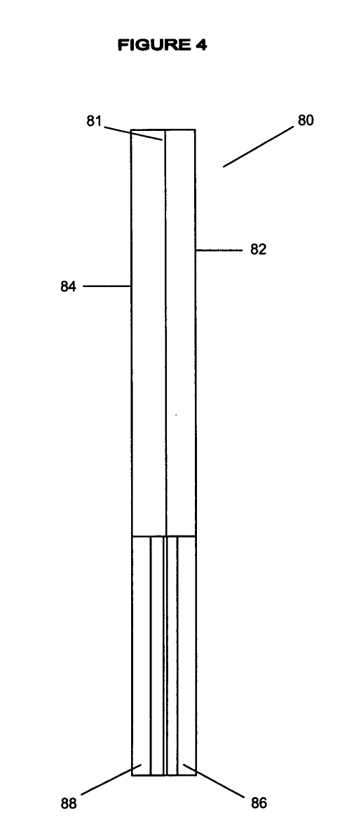

FIG. 4 presents a further side elevation view of the present invention which is taken along the transversely extending edges of the present invention. The assembly 80 is shown in a substantially closed position having first and second presentation folders 82 and 84 in a directly opposed configuration such that the pockets 86 and 88 are in a face to face alignment with one another. The medial fold line 81 of the first and second folders 82 and 84 is used to align the folders such that the medial fold lines, first and second edges and first and second sides are substantially parallel to one another.

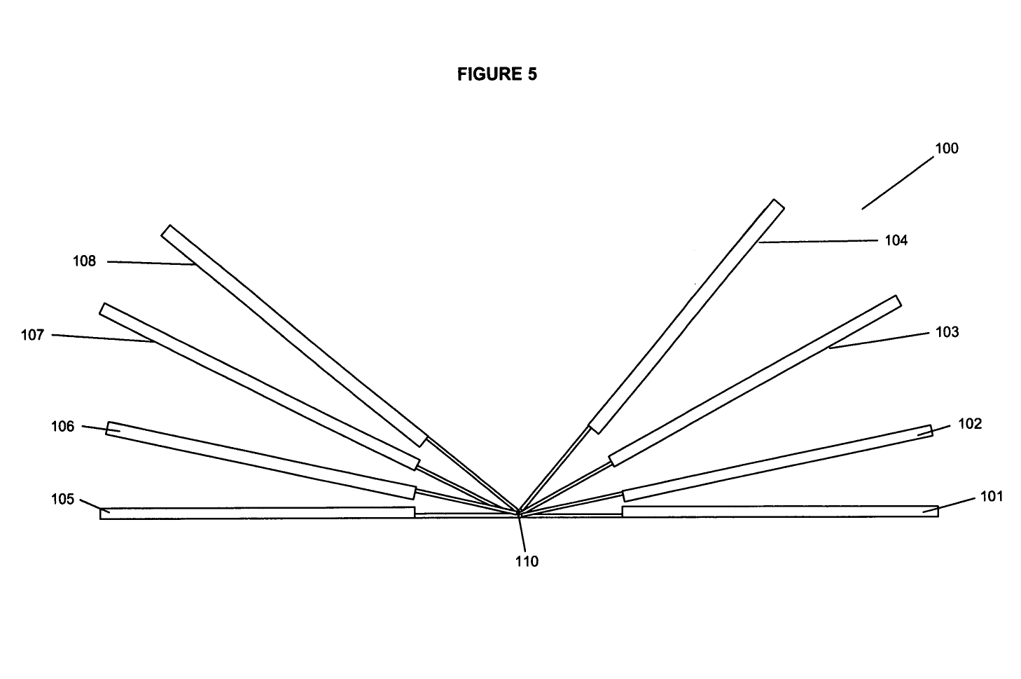

Turning now to FIG. 5 of the present invention, an end view, taken along the transversely extending end edges, is provided and shows a combined opposed pocketed configuration 100 in which first 101, second 102, third 103 and fourth 104 intermediate presentation folders have been assembled together medial fold lines represented by 110. As described previously and shown in the present drawing, each of the folder intermediates 101, 102, 103 and 104 are provided with first and second pockets on each of the first and second faces of the top surface of the assemblies. The pockets, for convenience are referred to solely as 105, 106, 107 and 108.

As can be seen from the drawing FIG. 5, the pockets 105 and 106 of folders 101 and 102 are in directly opposed relationship that is the pockets face each other and the pockets 107 and 108 of folders 103 and 104 are directly opposed to one another, again in a facial relationship.

It should be understood that the embodiment depicted in FIG. 5 is intended to be merely exemplary in its construction and that numerous configurations are possible, such as providing only three folder constructions, four or even many more. In a duplex type arrangement, that is two folders are disposed on one another, 4 pockets are present in the construction. With three folders in an assembly there would normally be 6 pockets, four folders 8 pockets and so on. In other constructions, a folder may only be provided with one pocket.

It will thus be seen according to the present invention a highly advantageous directly opposed; pocketed presentation folder assembly has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. An opposed pocketed intermediate presentation folder configuration, comprising;
at least first and second intermediate blanks, each of said blanks having first and second transversely extending edges, first and second longitudinally extending sides, top and bottom surfaces and first and second faces on each of said surfaces;
each of said first and second intermediate blanks is provided with first and second pockets with said first pocket disposed over said first face and said second pocket disposed over said second face;
a fold line on each of said blanks running between said transversely extending edges dividing each of said blanks into said first and second faces; and
wherein said second blank is juxtaposed on said first blank such that each of said longitudinally extending sides, transversely extending edges and said fold line are substantially in parallel with one another and said first and second pockets of each of said blanks are in a face to face alignment with one another creating an opposed pocket presentation folder assembly.

2. An opposed pocket intermediate presentation folder configuration as recited in claim 1, wherein said fold line runs substantially medially of each of said blanks such that each of said blanks is divided into substantially equal portions.

3. An opposed pocket intermediate presentation folder configuration as recited in claim 1, wherein each of said first and second pocket are less than half of each of said first and second faces.

4. An opposed pocket intermediate presentation folder configuration as recited in claim 1, wherein said opposed pocket presentation folder assembly has an open surface with no pockets centrally of said assembly for receiving printed and personalized information.

5. An opposed pocket intermediate presentation folder configuration as recited in claim 1, wherein said opposed pocket presentation folder assembly includes third and fourth intermediate blanks that are juxtaposed on said opposed pocket presentation folder assembly to create a second opposed pocket configuration adding up to eight pockets in said second pocket configuration.

6. An opposed pocket intermediate presentation folder configuration as recited in claim 1, wherein said opposed pocket presentation folder assembly includes four pockets with two pockets being on each of said first and second blanks.

7. An opposed pocket intermediate presentation folder configuration as recited in claim 1, wherein said opposed pocket presentation folder assembly includes slits for holding cards, discs, CDs, diskettes, tokens, chips and combinations thereof.

8. An opposed pocket intermediate presentation folder configuration as recited in claim 1, wherein each of said intermediate blanks is provided with first and second patterns of adhesive adjacent a portion of each of said first and second longitudinally extending sides to form a closed end pocket for each of said blanks.

9. An opposed pocket intermediate presentation folder configuration as recited in claim 1, wherein said bottom surface of said second intermediate blank is provided with a pattern of adhesive around a periphery to seal said first and second faces of said bottom surface together into a face-to-face configuration.

10. A presentation folder assembly having an opposed pocket configuration, comprising;
a first presentation folder having first and second transversely extending edges, first and second longitudinally extending sides, top and bottom surfaces, first and second faces on each of said top and bottom surfaces and first and second pockets with one of said first and second pockets provided on each of said first and second faces of said top surface;
at least a second presentation folder having first and second transversely extending edges, first and second longitudinally extending sides, top and bottom surfaces, first and second faces on each of said top and bottom surfaces and first and second pockets with one of said first and second pockets provided on each of said first and second faces of said top surface; and
wherein said second presentation folder is substantially juxtaposed over said first presentation folder so that said first and second pockets of said second presentation folder are in an opposed relationship to said first and second pockets of said first presentation folder and said first and second transversely extending edges and said first and second longitudinally extending sides are in parallel alignment with one another.

11. A presentation folder assembly having an opposed pocket configuration, as recited in claim 10, wherein said bottom surface of said second presentation folder is provided with a pattern adhesive along at least portions of said first and second transversely extending edges and first and second longitudinally extending sides to seal said first and second face of said bottom surface together.

12. A presentation folder assembly having an opposed pocket configuration, as recited in claim 10, wherein at least one of said first and second faces of said bottom surface of said second presentation folder is provided with printing.

13. A presentation folder assembly having an opposed pocket configuration, as recited in claim 10, wherein at least one of said first and second faces of said bottom face of said first presentation folder is provided with printing.

14. A presentation folder assembly having an opposed pocket configuration, as recited in claim 10, wherein a third presentation folder having first and second transversely extending edges, first and second longitudinally extending sides, top and bottom surfaces, first and second faces on each of said top and bottom surfaces and first and second pockets with one of said first and second pockets provided on each of said first and second faces of said top surface is juxtaposed over said bottom surface of said second presentation folder such that said first and second pockets of said third presentation folder are opposite said first and second pockets on said second presentation folder.

15. A presentation folder assembly having an opposed pocket configuration, as recited in claim 10, wherein each of said first and second pockets on each of said first and second presentation folders has a sealed end edge.

16. A presentation folder intermediate assembly having opposed pocket configurations, comprising;
a first blank of material having first and second transversely extending edges, first and second longitudinally extending sides, top and bottom surfaces with each surface having first and second faces, a medially extending fold line and first and second pocket portions formed from said blank having wing areas with each of said pocket portions folded over said first and second faces to form pockets when said wing areas are folded perpendicularly to said pocket portions;
at least a second blank of material having first and second transversely extending edges, first and second longitudinally extending sides, top and bottom surfaces with each surface having first and second faces, a medially extending fold line and first and second pocket portions formed from said blank having wing areas with each of said pocket portions folded over said first and second faces to form pockets when said wing areas are folded perpendicularly to said pocket portions; and
wherein said second blank of material is juxtaposed on and adhered to said first blank of material so that said first and second pocket portions are directly opposed to said first and second pocket portions of said first blank of material and said medial fold lines of each of said blanks are in substantial parallel alignment with one another.

17. A presentation folder intermediate assembly having opposed pocket configurations, as recited in claim 16, wherein said first and second faces of said bottom surface of said second blank are adhered to one another to form a sealed panel assembly.

18. A presentation folder intermediate assembly having opposed pocket configurations as recited in claim 16, wherein said first and second faces of each of said first blank of material and said second blank of material are provided with printing including graphical depictions.

19. A presentation folder intermediate assembly having opposed pocket configurations as recited in claim 16, wherein said assembly is provided with a third blank of material that is juxtaposed on said bottom surface of said second blank of material and having pockets that are disposed on a surface that is opposite to said first and second pocket portions of said second blank of material.

20. A presentation folder intermediate assembly having opposed pocket configurations as recited in claim 16, wherein each of said first and second blanks of material are provided with slits to hold cards, tags, discs, diskettes, chips and combinations thereof.
